(19) United States
(12) Patent Application Publication
(10) Pub. No.: US 2013/0294338 A1
(43) Pub. Date: Nov. 7, 2013

(54) METHOD AND DEVICE FOR INTERFERENCE COORDINATION AND COMMUNICATION SYSTEM, MOBILE STATION AND BASE STATION

(71) Applicant: Fujitsu Limited, Kawasaki-shi (JP)

(72) Inventors: Yi ZHANG, Beijing (CN); Yuantao ZHANG, Beijing (CN); Yuanrong LAN, Beijing (CN); Hua ZHOU, Beijing (CN); Jianming WU, Beijing (CN)

(21) Appl. No.: 13/933,360

(22) Filed: Jul. 2, 2013

Related U.S. Application Data
(63) Continuation of application No. PCT/CN2011/070089, filed on Jan. 7, 2011.

(51) Int. Cl. H04W 24/02

(52) U.S. Cl. CPC H04W 24/02
USPC 370/328

(57) ABSTRACT

A method and device for interference coordination in a communication system and the corresponding communication system, mobile station and base station (BS) are disclosed. In the method for interference coordination, a BS of a Pico Cell shifts a transmission frame backwards; a BS of a Macro Cell selects a sub-frame for transmitting a Channel State Information-Reference Signal (CSI-RS) from transmission frames of the Macro Cell itself, to enable the sub-frame of the BS of Macro Cell for transmitting CSI-RS to at least not overlap a sub-frame of the BS of the Macro Cell for transmitting a public channel and a sub-frame of the BS of Pico Cell partially; and the sub-frame of the BS of the Macro cell for transmitting the public channel at least does not overlap the sub-frame of the BS of Pico Cell for transmitting the public channel partially.

### CROSS-REFERENCE TO RELATED APPLICATIONS

The present application is a continuation of PCT Application No. PCT/CN2011/070089, now pending, filed on Jan. 7, 2011, the contents of which are herein wholly incorporated by reference.

### FIELD OF THE INVENTION

The present invention generally relates to the field of communication, in particular, to a method and a device for interference coordination in a communication system such as LTE-A (Long Term Evolution-Advanced) system and corresponding communication system, mobile station and base station.

### BACKGROUND OF THE INVENTION

In the next-generation wireless communication system advanced long-term evolution (ie., LTE-A), the concept of heterogeneous networks was introduced. LTE-A heterogeneous network system may include macro cell (Macro Cell), femto cell (Femto Cell), pico cell (Pico Cell), remote radio head (RRH), relay (Relay) and so on. FIG. 1 is a schematic diagram showing a heterogeneous communication system including the above-mentioned nodes (macro cell, femto cell, pico cell etc.).

The newly deployed wireless nodes not only improve the capacity of system, but also provide better services to users in special areas and optimize system performance.

However, the newly deployed nodes may bring interference to users in the originally deployed cell, and even cause some covered holes.

For example, in the scenario of macro cell and pico cell being mixed, cell expansion technology is often employed to improve cell capacity. Specifically, a part of mobile stations belonging to macro cell service are changed to belong to pico cell service by changing the cell selection rules for mobile station. FIG. 2 shows the interference on the mobile station changed from macro cell service to pico cell service in the scenario of macro cell and pico cell being mixed.

The mobile station subjected to cell expansion process may be interfered with by macro cell when communicating through pico cell.

For example, the transmission of a common channel for carrying broadcast information of a macro cell may affect the transmission of a common channel for carrying broadcast information of a pico cell, and the transmission of the Channel State Information-Reference Signal (CSI-RS) of a macro cell may affect a common channel of a pico cell. These interferences are more apparent, especially in the case of adopting energy improving technique in the macro-cell.

Wherein, the position of CSI-RS in the physical transmission resource depends on the system configuration; however, the physical transmission resource of a common channel is generally predetermined, said common channel referring to the channel for broadcasting the information to be received in the communication process, for example, the common channel may include a broadcast channel (PBCH), a synchronization channel (PSS/SSS), a master system information block (SIB1) and a paging channel (PCH).

For example, Table 1 shows the common channel in frequency division duplex (FDD) system and the physical transmission resources for CSR-RS transmission.

| | | | OFDM |
|---|---|---|---|
| | | Sub-frame position | symbol position (in |
| Name | Period (sub-frame) | (within one frame) | one resource block) |
| CSI-RS | 5, 10, 20, 40 | Depending on | 5, 6, 9, 10, 12, 13 |
| | | configuration | (possible) |
| PBCH | 10 | 0 | 7, 8, 9, 10 |
| PSS | 5 | 0, 5 | 6 |
| SSS | 5 | 0, 5 | 5 |
| SIB1 | 20 | 5 | PDSCH symbol |
| Paging | Depending on | 0, 4, 5, 9/9/4, 9 | PDSCH symbol |
| | configuration | | |

As can be seen from Table 1, as to a frame typically including 10 sub-frames, the common channel occupies the 0th, 4th, 5th, 9th sub-frames. Specifically, the PBCH channel occupies the 0th sub-frame, the PSS channel occupies the 0th and 5th sub-frames, the SSS channel occupies the 0th and 5th sub-frames, the SIB1 channel occupies the 5th sub-frame, and the Paging channel may occupy the 0th, 4th, 5th, 9th sub-frames, or the 9th sub-frame, or the 4th and 9th sub-frame depending on different configurations.

In addition, Table 1 shows the transmission period of the CSI-RS and the common channel and the OFDM symbol position of the CSI-RS and the common channel in the resource block.

If a sub-frame for carrying CSI-RS of a macro cell base station or a sub-frame occupied by a common channel of the macro cell base station is overlapped with a sub-frame occupied by a common channel for transmitting broadcast information of a pico cell, the macro cell may bring interference to the pico cell, affecting the reliable transmission of the common channel of the pico cell. Furthermore, if a sub-frame for carrying CSI-RS of a macro cell base station is overlapped with a sub-frame for common channel of the macro cell itself, the transmission of the CSI-RS of the macro cell may also affect the common channel of the macro cell itself.

### SUMMARY OF THE INVENTION

Accordingly, one object of the present invention is to eliminate one of interference as follows: the interference caused by the CSI-RS (including the affection on the macro cell and the affection on the pico cell) and the interference on the pico cell caused by the common channel of the macro cell. Specifically, an embodiment of the present invention provides method and device for interference coordination and associated communication system, mobile station and base station.

Through the method and device for interference coordination according to an embodiment of the present invention, the interference caused by the CSI-RS and the interference on the pico cell caused by the common channel of the macro cell can at least partly be eliminated.

One embodiment of the present invention provides a method for coordinating interference in a communication system, comprising: collecting and sending, by a macro-cell base station in the communication system, interference coordination information in connection with Channel State Information-Reference Signal of the macro cell base station to a pico cell base station; and sending, by the pico cell base station in the communication system, the interference coordination information to a user equipment serviced by the pico cell base station, so as to coordinate interference on the pico cell caused by the macro cell according to the interference coordination information.

Another embodiment of the present invention provides a method for coordinating interference in a communication system, comprising: receiving, by a user equipment in the communication system, interference coordination information in connection with Channel State Information-Reference Signal of a macro cell base station from a pico cell base station serving the user equipment; eliminating, by the user equipment, interference information from the received information according to the interference coordination information, so as to eliminate the interference on the pico cell caused by the macro cell.

Still another embodiment of the present invention provides a method for coordinating interference in a communication system, comprising: informing, by a marco cell base station in the communication system, a pico cell base station in the communication system to postpone a transmission frame of the pico cell base station according to a frame structure of the macro cell base station itself; and selecting, by the macro cell base station, a sub-frame for carrying the Channel State Information-Reference Signal from the transmission frame of the macro cell base station itself according to a postponing length of the transmission frame of the pico cell base station; wherein, the sub-frame for carrying the Channel State Information-Reference Signal selected by the macro cell base station is at least partly not overlapped with sub-frames for carrying common channels of the macro cell base station and sub-frames for carrying common channels of the pico cell base station; and the sub-frames for carrying common channels of the macro cell base station is at least partly not overlapped with the sub-frames for carrying common channels of the pico cell base station.

One embodiment of the present invention provides a device for coordinating interference in a communication system, comprising: an interference coordination information generating section configured to generate interference coordination information in connection with Channel State Information-Reference Signal of the device and send the interference coordination information to a pico cell base station in the communication system; wherein, the interference coordination information is sent to a user equipment serviced by the a pico cell base station, so as to coordinate interference on the pico cell caused by the macro cell according to the interference coordination information.

Another embodiment of the present invention provides a device for coordinating interference in a communication system, comprising: an interference coordination information receiving section configured to receive interference coordination information in connection with Channel State Information-Reference Signal of a macro cell base station in the communication system from the macro cell base station; and an interference coordination information sending section configured to send the interference coordination information to a user equipment serviced by the device, so as to coordinate interference on the pico cell corresponding to the device caused by the macro cell according to the interference coordination information.

Still another embodiment of the present invention provides a device for coordinating interference in a communication system, comprising: a receiving section configured to receive interference coordination information in connection with Channel State Information-Reference Signal of a macro cell base station in the communication system from a pico cell base station in the communication system; an eliminating section configured to eliminate interference information from the received information according to the interference coordination information so as to eliminate the interference on the pico cell caused by the macro cell.

Still yet another embodiment of the present invention provides a device for coordinating interference in a communication system, comprising: a postponing section configured to postpone a transmission frame of a pico cell base station in the communication system according to a frame structure of a macro cell base station in the communication system; a selecting section configured to select a sub-frame for carrying the Channel State Information-Reference Signal from the transmission frame of the macro cell base station according to a postponing length of the transmission frame of the pico cell base station; wherein, the sub-frame for carrying the Channel State Information-Reference Signal selected by the selecting section is at least partly not overlapped with sub-frames for carrying common channels of the macro cell base station and sub-frames for carrying common channels of the pico cell base station; and the sub-frames for carrying common channels of the macro cell base station is at least partly not overlapped with the sub-frames for carrying common channels of the pico cell base station.

Furthermore, the embodiments of the present invention provide corresponding base station and user equipment and the communication system including the base station and the user equipment.

### BRIEF DESCRIPTION OF THE DRAWINGS

FIG. 1 is a schematic diagram illustrating the structure of a heterogeneous communication system;

FIG. 2 illustrates the interference on the mobile station changed from macro cell service to pico cell service in the scenario of macro cell and pico cell being mixed;

FIG. 3 illustrates a flowchart of a method for interference coordination according to an embodiment of the present invention;

FIG. 4 illustrates a flowchart of a method for interference coordination according to an embodiment of the present invention;

FIG. 5 is a flowchart illustrating a process of eliminating interference by a user equipment using interference coordination message according to an embodiment of the present invention;

FIG. 6 illustrates a flowchart of a method for interference coordination according to another embodiment of the present invention;

FIG. 7 is a schematic diagram illustrating a transmission frame of a macro cell base station and a transmission frame of a pico cell base station according to a preferred embodiment of the present invention;

FIG. 8 is a schematic diagram illustrating a transmission frame of a macro cell base station and a transmission frame of a pico cell base station according to a preferred embodiment of the present invention;

FIG. 9 is a schematic diagram illustrating a transmission frame of a macro cell base station and a transmission frame of a pico cell base station according to a modified embodiment of the present invention;

FIG. 10 is a schematic diagram illustrating a transmission frame of a macro cell base station and a transmission frame of a pico cell base station according to a modified embodiment of the present invention;

FIG. 11 is a schematic diagram illustrating a transmission frame of a macro cell base station and a transmission frame of a pico cell base station according to a modified embodiment of the present invention;

FIG. 12 is a schematic diagram illustrating a transmission frame of a macro cell base station and a transmission frame of a pico cell base station according to a modified embodiment of the present invention;

FIG. 13 is a schematic diagram illustrating a transmission frame of a macro cell base station and a transmission frame of a pico cell base station according to a modified embodiment of the present invention;

FIG. 14 is a schematic diagram illustrating a transmission frame of a macro cell base station and a transmission frame of a pico cell base station according to a modified embodiment of the present invention;

FIG. 15 is a schematic diagram illustrating a transmission frame of a macro cell base station and a transmission frame of a pico cell base station according to a modified embodiment of the present invention;

FIGS. 16a and 16b respectively illustrates a device for interference coordination according to an embodiment of the present invention;

FIG. 17 illustrates a schematic diagram of a device for interference coordination according to an embodiment of the present invention;

FIG. 18 illustrates a schematic diagram of an eliminating section according to an embodiment of the present invention;

FIG. 19 illustrates a device for interference coordination according to another embodiment of the present invention; and

FIG. 20 is a block diagram illustrating an exemplary structure of a computer in which the device and the method of the present invention is implemented.

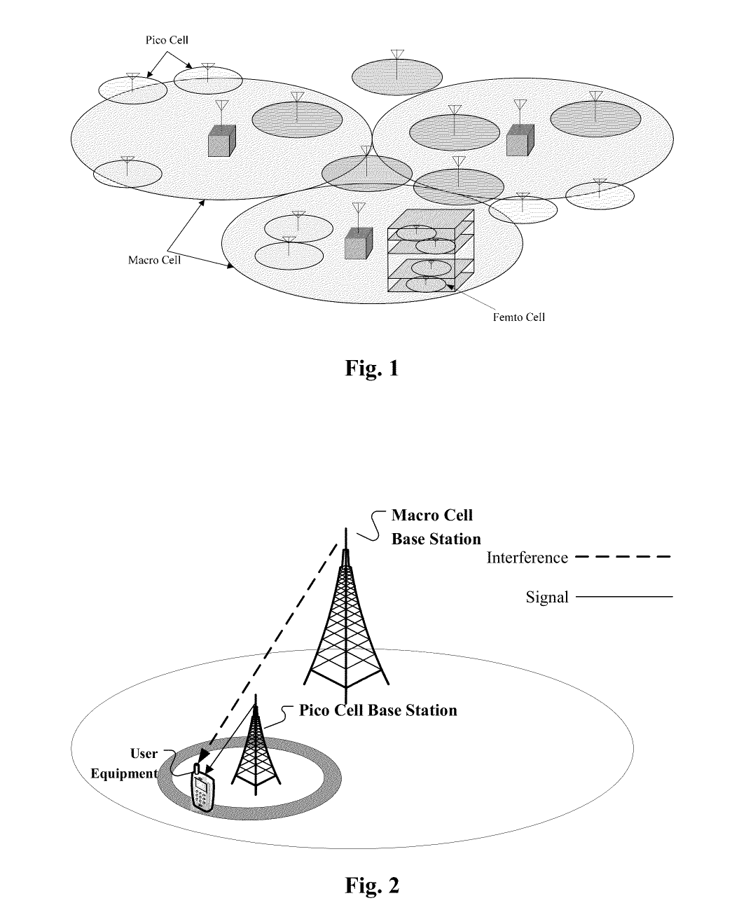

### DETAILED DESCRIPTION OF THE INVENTION

The embodiments of the present disclosure will be described in conjunction with the accompanying drawings hereinafter. It should be noted that some components and/or processes irrelevant to the disclosure or well known in the art are omitted from the figures and the description for the sake of clarity.

The following description will take the LTE-A wireless communication system as example, but it is obviously that the present invention is not limited thereto, the skilled person will recognize that the inventive concepts disclosed herein can be applied to other communication systems that existed or will appear in the future.

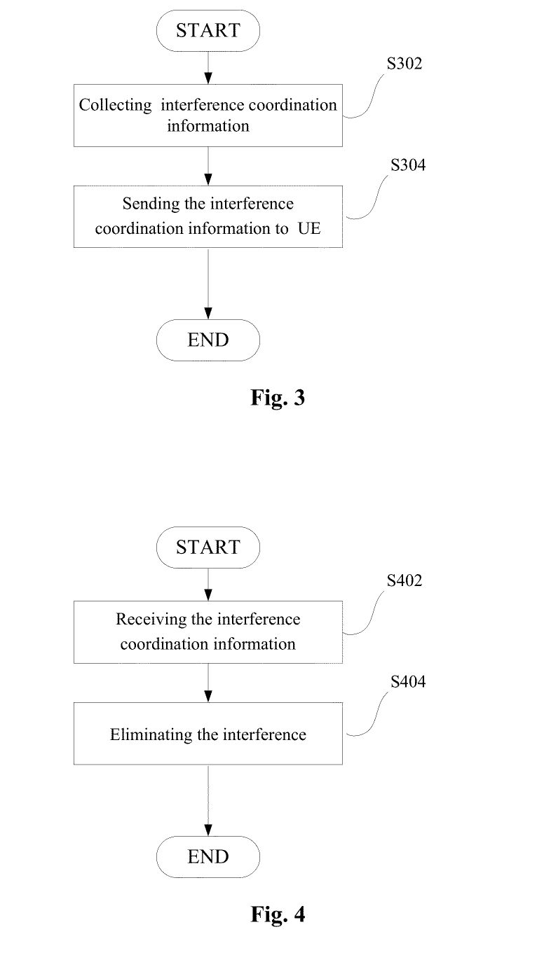

As shown in FIG. 3, the method for interference coordination according to an embodiment of the present invention includes step S302 and step S304.

In step S302, a macro cell base station collects and sends the CSI-RS related interference coordination information to a pico cell base station.

Specifically, the macro-cell base station collects CSI-RS related configuration information, and send it to the related pico cell base station as interference coordination information through the interface between the base stations (eg., X2 interface).

Next, in step S304, the pico cell base station sends the received interference coordination information to a user equipment (UE) served by the pico cell base station.

Specifically, the pico cell base station may send the CSI-RS related interference coordination information received from the macro cell base station to the UE served by the pico cell base station via the communication signaling between the UE and the base station (e.g., the radio resource control signaling, i.e., RRC signaling).

In this way, the CSI-RS related interference coordination information of the macro cell base station may be send to the UE served by the pico cell base station, facilitating the achievement of interference coordination.

In an implementation of the present invention, the interference coordination information collected by the macro cell base station and sent by the pico cell base station to the UE served by the pico cell base station may include, for example, a period of the CSI-RS, a position of a sub-frame carrying the CSI-RS, a position of the CSI-RS in time-frequency resources, a transmission symbol of the CSI-RS and a transmission power of the CSI-RS.

The period of the CSI-RS, the position of a sub-frame carrying the CSI-RS, and the position of the CSI-RS in time-frequency resources are information related to the transmission position of the CSI-RS; while the transmission symbols of CSI-RS is the information related to the transmission form and can be determined based on a slot number, a cell identifier and cyclic prefix information; and the transmission power of the CSI-RS is information related to the transmission power.

With the above-described CSI-RS related information, the information related to the CSI-RS transmission can be provided to the UE. Thus, the UE may also eliminate the information from the received information based on the CSI-RS related interference coordination information.

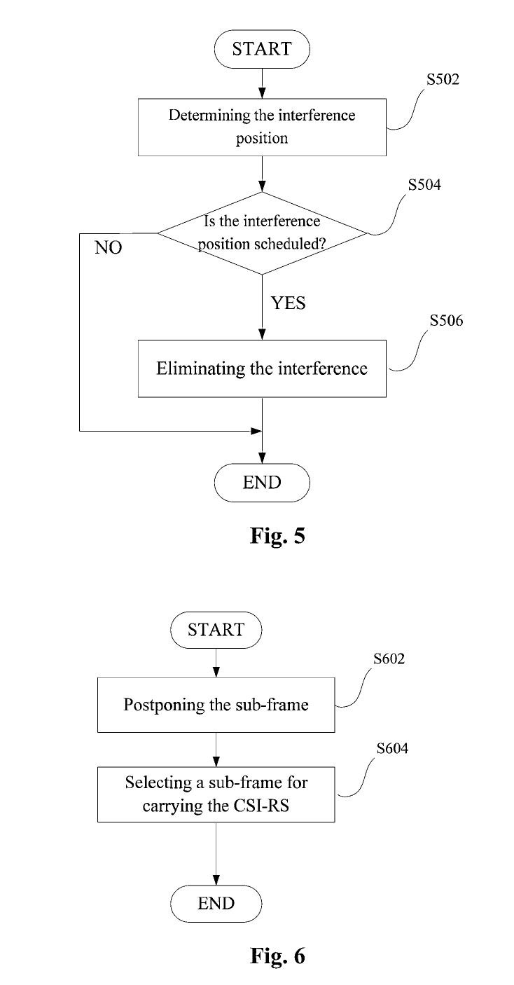

FIG. 4 illustrates a flowchart of a method for interference coordination in a communication system according to an embodiment of the present invention.

As shown in FIG. 4, in step S402, the UE receives the interference coordination information.

Specifically, the UE receives the CSI-RS related interference coordination information that is collected by the macro cell base station in a communication system from the pico cell base station serving the UE.

Next, in step S404, the UE eliminates the interference caused by the CSI-RS from the received information based on the received interference coordination information.

By the above-described method, the UE can eliminate the interference on the pico cell caused by the transmission of CSI-RS by the macro cell base station.

In the method according to an embodiment of the present invention shown in FIG. 4, the CSI-RS related interference coordination information may be the interference coordination information collected by the macro cell base station in the method shown in FIG. 3, for example, it can include: a period of the CSI-RS, a position of a sub-frame carrying the CSI-RS, a position of the CSI-RS in time-frequency resources, a transmission symbol of the CSI-RS and a transmission power of the CSI-RS.

According to an embodiment of the present invention, the UE may eliminate the interference of the CSI-RS by using interference coordination message through the following process.

FIG. 5 is a flowchart illustrating a process of eliminating interference by a UE using interference coordination message according to an embodiment of the present invention.

As shown in FIG. 5, in step S502, the UE can determine the CSI-RS transmission sub-frame position according to the interference coordination information.

Specifically, the UE can determine the position of sub-frame for carrying CSI-RS in the macro cell base station according to a period of the CSI-RS, a position of a sub-frame carrying the CSI-RS, a position of the CSI-RS in time-frequency resources of the CSI-RS related interference coordination information. Thus, the UE can determine the interference position.

Next, as shown in FIG. 5, in step S504, the UE can judge whether there is a resource scheduling in the interference position.

Specifically, if the UE found that there is no information transmission for the UE in the interference position, the UE can judge that there is no resource scheduling in the interference position and end the process.

On the other hand, if the UE found that there is information transmission for the UE in the interference position, the UE can judge that there is resource scheduling in the interference position and proceeds to step S506.

In step S506, the UE can eliminate the affection of interference from the received signal according to the CSI-RS related interference coordination information.

Specifically, the UE can further determine the magnitude of interference according to a transmission symbol of the CSI-RS and a transmission power of the CSI-RS of the interference coordination information, and eliminate the affection of interference from the received signal at the interference position based on the determined magnitude of interference.

In this way, the UE can eliminate the affection caused by the macro cell base station transmitting CSI-RS from the received information, thus ensuring the quality of the received information.

In the method for interference coordination according to the above-described embodiment, the UE eliminates the affection of interference from the received signal based on the interference coordination information from the base station side. That is, the interference on the pico cell caused by the macro cell base station transmitting CSI-RS is eliminated at the UE side.

However, the method provided above is just an example, the present invention is not limited thereto. In another embodiment of the present invention, the interference on the pico cell caused by the macro cell base station can be eliminated or alleviated at the base station side.

FIG. 6 illustrates a flowchart of a method for interference coordination according to another embodiment of the present invention.

As shown in FIG. 6, the method for interference coordination according to the embodiment includes postponing a sub-frame in step S602 and selecting a sub-frame for transmitting the CSI-RS in step S604.

Specifically, in the process for interference coordination according to the embodiment, in step S602, the macro cell base station can inform the pico cell base station to postpone a transmission frame according to the frame structure of the macro cell base station (specifically, the position of the sub-frame occupied by the public channel). Next, in step S604, the macro cell base station can select the sub-frame for carrying the CSI-RS according to the shift length of the transmission frame of pico cell base station; such that: the sub-frame for carrying the CSI-RS selected by the macro cell base station is at least partly not overlapped with sub-frames for carrying common channels of the macro cell base station and sub-frames for carrying common channels of the pico cell base station; and the sub-frames for carrying common channels of the macro cell base station is at least partly not overlapped with the sub-frames for carrying common channels of the pico cell base station.

In the interference coordination process that is implemented in the base station side, the transmission frame of the macro cell base station and the transmission frame of the pico cell base station is reasonably arranged so as to avoid the interference on the pico cell caused by the macro cell. Specifically, when the transmission frame of the macro cell base station and the transmission frame of the pico cell base station are arranged, the following three limitations need to be considered.

1. the sub-frame for carrying the CSI-RS of the macro cell base station is not overlapped with the sub-frame for carrying the common channel of the macro cell base station.

As can be seen in Table 1, the sub-frame for carrying the common channel is the 0th, 4th, 5th, 9th sub-frame in the frame. Accordingly, in order to satisfy the first limitation, the sub-frame for carrying the CSI-RS selected by the macro cell base station can not be the 0th, 4th, 5th, 9th sub-frame of the transmission frame of the macro cell, so as to avoid the CSI-RS transmitted by the macro cell base station bringing interference to the common channel of the macro cell base station itself.

2. the sub-frame for carrying the CSI-RS of the macro cell base station is not overlapped with the sub-frame for carrying the common channel of the pico cell base station.

As can be seen in Table 1, the sub-frame for carrying the common channel is the 0th, 4th, 5th, 9th sub-frame in the frame. Accordingly, in order to satisfy the second limitation, the sub-frame for carrying the CSI-RS selected by the macro cell base station can not be overlapped with the sub-frame for carrying the common channel of the pico cell, so as to avoid the CSI-RS transmitted by the macro cell base station bringing interference to the common channel of the pico cell.

3. the sub-frame for carrying the common channel of the macro cell base station is not overlapped with the sub-frame for carrying the common channel of the pico cell base station.

As described above, the sub-frames for carrying the common channel of the macro cell base station and the pico cell base station are the 0th, 4th, 5th, 9th sub-frame in the transmission frame. Accordingly, to satisfy the third limitation, the transmission frame of the pico cell base station can be shifted, and the shifted sub-frame for carrying the common channel of the pico cell base station (ie., the 0th, 4th, 5th, 9th sub-frame in the shifted transmission frame) can not be overlapped with the sub-frame for carrying the common channel of the macro cell base station, so as to avoid the common channel of the macro cell base station bringing interference to the common channel of the pico cell base station.

There are a variety of configurations to satisfy the above three limitations. The following configurations according to an embodiment the present invention is provided as examples to illustrate how to avoid or alleviate the interference cause by the macro cell transmitting the CSI-RS and the interference between the common channel of the macro cell and the common channel of the pico cell. However, these configurations are merely examples, the present invention is not limited thereto, and various changes can be made according to the actual situation.

### Preferred Example 1

In one preferred embodiment of the present invention, the macro cell base station can inform the pico cell base station to postpone the transmission frame of the pico cell base station by 2 sub-frames according to the frame structure of the macro cell base station itself, such that the sub-frames occupied by the common channel in the transmission frame of the pico cell base station are not overlapped with the sub-frames occupied by the common channel in the transmission frame of the macro cell base station. And the macro cell base station can select the 3th sub-frame and/or the 8th sub-frame in the transmission frame of the macro cell base station to carry the CSI-RS, such that the sub-frame for carrying the CSI-RS of the macro cell base station is not overlapped with the sub-frame occupied by the common channel of the pico cell base station.

FIG. 7 is a schematic diagram illustrating a transmission frame of a macro cell base station and a transmission frame of a pico cell base station according to a preferred embodiment of the present invention.

In FIG. 7, the upper portion is the transmission frame of the macro cell base station (12 sub-frames are shown, wherein the 0-9th sub-frames compose one transmission frame), the lower portion is the transmission frame of the pico cell base station (similarly, 12 sub-frames are shown, wherein the 0-9th sub-frames compose one transmission frame), the hatching portions represent the sub-frames for carrying the common channel of the macro cell base station and the pico cell base station respectively, and the sub-frames for carrying the CSI-RS in the transmission frame of the macro cell base station are marked by ellipses. Furthermore, the structure of the transmission frame (including the subsequent frame structure diagram) illustrated in FIG. 7 (e.g., a transmission frame length of 10 sub-frames) is merely an example, the present invention is not limited thereto, for example, the frame length can also be extended to any other suitable length, and the position of the empty sub-frame in the transmission frame can be further configured by the system. Furthermore, FIG. 7 is provided to illustrate the inventive concept of the present invention, in which a transmission frame including 10 sub-frames is shown as an example. Of course, it is easy to understand that in the case of a transmission frame including more sub-frames or a unit of a transmission frame including more transmission frames, only one section of an unit block of the transmission frame is shown in FIG. 7, and it is obviously that the inventive concept of the present invention can be extended to a unit of a transmission frame in full-length that is not shown completely (similarly in the following figures).

In FIG. 7, the sub-frame for carrying the CSI-RS or the sub-frame for carrying the common channel of the macro cell base station may bring interference to the corresponding sub-frame of the pico cell base station below. For example, when the sub-frame of the pico cell base station corresponding to the sub-frame for carrying the CSI-RS or the sub-frame for carrying the common channel of the macro cell base station carries the common channel, the CSI-RS of the macro cell base station or the common channel of the macro cell base station may bring interference to the common channel of the pico cell base station.

As shown in FIG. 7, the macro cell base station can inform the pico cell base station to postpone the transmission frame backwards by 2 sub-frames according to the frame structure of the macro cell base station itself, such that the 0th sub-frame in the transmission frame of the pico cell base station is overlapped with the 2th sub-frame in the transmission frame of the macro cell base station.

In the case of the transmission frame of the pico cell base station being postponed by 2 sub-frames, it can be ensured that the sub-frame for carrying the common channel of the macro cell base station being not overlapped with the sub-frame for carrying the common channel of the pico cell base station, thereby avoid the interference on the common channel of the pico cell base station caused by the common channel of the macro cell base station.

In the case of the transmission frame of the pico cell base station being postponed by 2 sub-frames, when the macro cell base station selects the 3th sub-frame or the 8th sub-frame to carry the CSI-RS, the sub-frame for carrying the CSI-RS is not overlapped with the sub-frame for carrying the common channel of the pico cell base station, and is not overlapped with the sub-frame for carrying the common channel of the macro cell base station itself, thereby avoid the interference on the common channel of the macro cell base station and the common channel of the pico cell base station caused by the macro cell base station transmitting the CSI-RS.

Accordingly, the interference on the common channel of the pico cell base station caused by the common channel of the macro cell base station and the interference on the common channel of the macro cell base station and the common channel of the pico cell base station caused by the CSI-RS of the macro cell can be completely eliminated by shifting the sub-frame of the pico cell base station and selecting the sub-frame for carrying the CSI-RS of the macro cell base station by the manner shown in FIG. 7.

Further considering the requirements for periodicity of the CSI-RS transmission shown in Table 1, it can be seen that the transmission scheme for interference coordination that can be realized in the embodiment shown in FIG. 7 including: a macro cell base station transmits the CSI-RS using the 3th sub-frame and/or the 8th sub-frame (whether to use the 3th sub-frame and the 8th sub-frame simultaneously is determined according to the transmission period) of the transmission frame (such as a transmission frame of 10 sub-frames).

More specifically, it can be seen from Table 1 that the transmission period of the CSI-RS may be 5 sub-frames, 10 sub-frames, 20 sub-frames or 40 sub-frames depending on different application scenarios.

For example, in a case that the transmission period of the CSI-RS is 10 sub-frames, 20 sub-frames or 40 sub-frames, the sub-frame for carrying the CSI-RS of the macro cell base station may be the 3th sub-frame or the 8th sub-frame to meet the requirements for the transmission period of the CSI-RS.

For example again, in a case that the transmission period of the CSI-RS is 5 sub-frames, the sub-frame for carrying the CSI-RS of the macro cell base station may be the 3th sub-frame and the 8th sub-frame to meet the requirements for the transmission period of the CSI-RS.

### Preferred Example 2

In another preferred embodiment of the present invention, the macro cell base station can inform the pico cell base station to postpone the transmission frame by 3 sub-frames according to the frame structure of the macro cell base station itself, such that the sub-frames occupied by the common channel in the transmission frame of the pico cell base station are not overlapped with the sub-frames occupied by the common channel in the transmission frame of the macro cell base station. And the macro cell base station can select the 1th sub-frame and/or the 6th sub-frame in the transmission frame of the macro cell base station to carry the CSI-RS, such that the sub-frame for carrying the CSI-RS of the macro cell base station is not overlapped with the sub-frame occupied by the common channel of the pico cell base station.

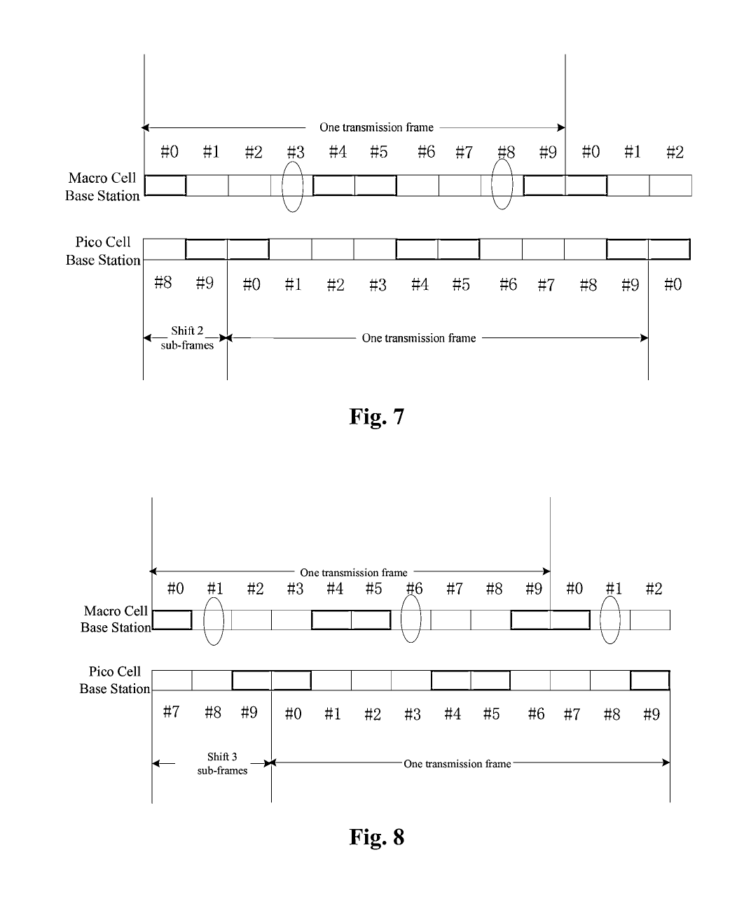

FIG. 8 is a schematic diagram illustrating a transmission frame of a macro cell base station and a transmission frame of a pico cell base station according to a preferred embodiment of the present invention;

Like FIG. 7, in FIG. 8, the upper part is the transmission frame of the macro cell base station including 10 sub-frames, the lower part is the transmission frame of the pico cell base station including 10 sub-frames, the hatching parts represent the sub-frames for carrying the common channel, and the sub-frames for carrying the CSI-RS in the transmission frame of the macro cell base station are marked by ellipses.

As shown in FIG. 8, the transmission frame of the pico cell base station is postponed by 3 sub-frames, therefore, the 0th sub-frame of the transmission frame of the pico cell base station is overlapped with the 3th sub-frame of the transmission frame of the macro cell base station.

In the case that the transmission frame of the pico cell base station is postponed by 3 sub-frames, it can be ensured that the sub-frame for carrying the common channel of the macro cell base station is not overlapped with the sub-frame for carrying the common channel of the pico cell base station, thereby avoid the interference on the common channel of the pico cell base station caused by the common channel of the macro cell base station.

In the case that the transmission frame of the pico cell base station is postponed by 3 sub-frames, when the macro cell base station selects the 1th sub-frame or the 6th sub-frame to carry the CSI-RS, the sub-frame for carrying the CSI-RS not only is not overlapped with the sub-frame for carrying the common channel of the pico cell base station, but also not overlapped with the sub-frame for carrying the common channel of the macro cell base station itself, thereby avoid the interference on the common channel of the macro cell base station and the common channel of the pico cell base station caused by the macro cell base station transmitting the CSI-RS.

Accordingly, the interference on the common channel of the pico cell base station caused by the common channel of the macro cell base station and the interference on the common channel of the macro cell base station and the common channel of the pico cell base station caused by the CSI-RS of the macro cell can be completely eliminated by postponing the sub-frame of the pico cell base station and selecting the sub-frame for carrying the CSI-RS of the macro cell base station by the manner shown in FIG. 8.

Further considering the requirements for periodicity of the CSI-RS transmission shown in Table 1, it can be seen that the transmission configuration scheme for interference coordination that can be realized in the embodiment shown in FIG. 8 including: a macro cell base station transmits the CSI-RS using the 1th sub-frame and/or the 6th sub-frame (whether to use the 1th sub-frame and the 6th sub-frame simultaneously is determined according to the transmission period) of the transmission frame (such as a transmission frame of 10 sub-frames).

More specifically, it can be seen from Table 1 that the transmission period of the CSI-RS may be 5 sub-frames, 10 sub-frames, 20 sub-frames or 40 sub-frames depending on different application scenarios.

For example, in the case that the transmission period of the CSI-RS is 10 sub-frames, 20 sub-frames or 40 sub-frames, the sub-frame for carrying the CSI-RS of the macro cell base station may be the 1th sub-frame or the 6th sub-frame to meet the requirements for the transmission period of the CSI-RS.

For example again, in the case that the transmission period of the CSI-RS is 5 sub-frames, the sub-frame for carrying the CSI-RS of the macro cell base station may be the 1th sub-frame and the 6th sub-frame to meet the requirements for the transmission period of the CSI-RS.

The interference on the common channel of the macro cell and the common channel of the pico cell caused by the transmission of the CSI-RS of the macro cell base station can be completely eliminated by the postponing and selecting process of the above preferred embodiment, furthermore, the interference on the common channel of the pico cell caused by the common channel of the macro cell can be completely eliminated.

However, the above-described preferred embodiments are only examples, the present invention is not limited thereto, and for a variety of application requirements, such as in interference scenarios that are more lenient to those requirements, embodiments of the present invention can also be appropriate changed to have greater flexibility.

Example Scenario 1 in which only the SIB1 channel and the Paging channel need to be ensured of not being interfered with by the CSI-RS.

In some applications that only the SIB1 channel and the Paging channel need to be ensured of not being interfered with by the CSI-RS, the limitations to the position of the sub-frame for carrying the CSI-RS of the macro cell base station can be alleviated as appropriate.

Considering the above preferred example 1 and 2, it can be seen that, to ensure that the common channel of the macro cell base station will not bring interference to the common channel of the pico cell base station, the macro cell base station may inform the pico cell base station to postpone the transmission frame thereof by 2 sub-frames or 3 sub-frames according to the frame structure of the macro cell base station itself.

In a modified embodiment of the present invention, the pico cell base station can postpone the transmission frames by 2 sub-frames. In this case, the macro cell base station may carry the CSI-RS by the 2th sub-frame or the 6th sub-frame in addition to the 3th sub-frame and/or the 8th sub-frame of the preferred example 1.

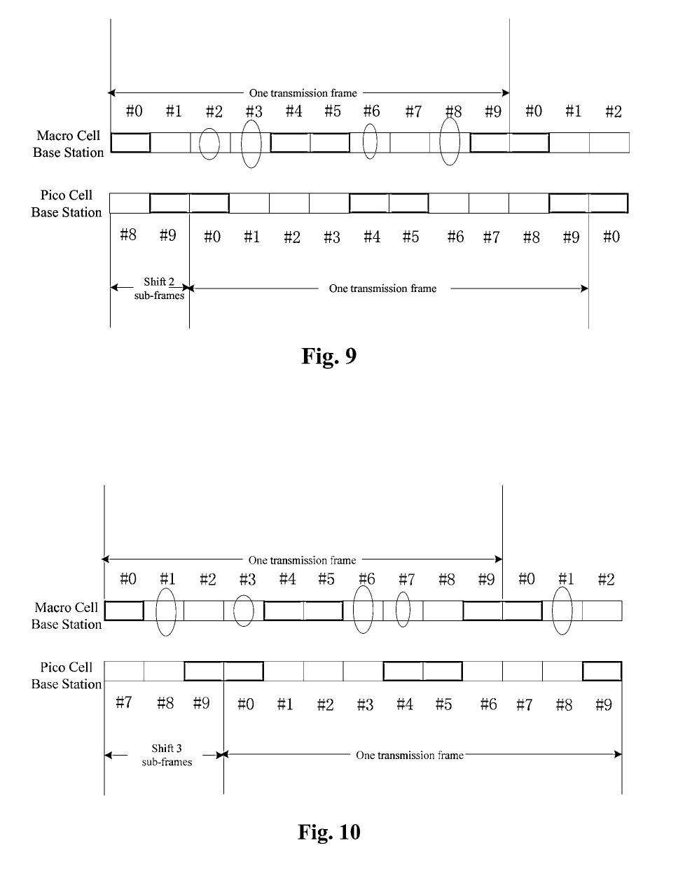

FIG. 9 is a schematic diagram illustrating a transmission frame of a macro cell base station and a transmission frame of a pico cell base station according to the above modified embodiment of the present invention. As shown in FIG. 9, in addition to the 3th sub-frame and/or the 8th sub-frame of the preferred example 1, the macro cell base station can carry the CSI-RS by the 2th sub-frame or the 6th sub-frame to ensure that the SIB1 channel and the Paging channel of the pico cell base station is not interfered with by the CSI-RS transmitted by the macro cell base station. In FIG. 9, the sub-frames that can carry the CSI-RS simultaneously (such as the 3th sub-frame and the 8th sub-frame) are marked by ellipses of same size, and the sub-frames that can not carry the CSI-RS simultaneously (such as the 2th sub-frame and the 6th sub-frame) are marked by ellipses of different size (similarly in the following figures).

Further considering the requirements for periodicity of the CSI-RS transmission shown in Table 1, it can be seen that the transmission configuration scheme for interference coordination that can be realized in the embodiment shown in FIG. 9 includes: a macro cell base station transmits the CSI-RS using the 3th sub-frame and/or the 8th sub-frame (whether to use the 3th sub-frame and the 8th sub-frame simultaneously is determined according to the transmission period) of the transmission frame (such as a transmission frame of 10 sub-frames); or transmits the CSI-RS using the 2th sub-frame or the 6th sub-frame.

Referring to Table 1, the SIB1 channel occupies the 5th sub-frame of the frame, and the Paging channel may occupy the 0th, 4th, 5th, 9th sub-frames, the 9th sub-frame, or the 4th, 9th sub-frames. In the present embodiment, the Paging channel can be configured to occupy the 9th sub-frame or the 4th, 9th sub-frames.

As shown in FIG. 9, when the macro cell base station carries the CSI-RS by the 2th sub-frame, the transmission of the CSI-RS in the macro cell base station may bring interference to the 0th sub-frame of the pico cell base station. In the present embodiment, the SIB1 channel does not occupy the 0th sub-frame, and the Paging channel may not occupy the 0th sub-frame (in the case that the Paging channel is configured to occupy the 9th sub-frame or the 4th, 9th sub-frames), therefore, it can be ensured that the SIB1 channel and the Paging channel of the pico cell base station are not interfered with by the CSI-RS transmitted in the macro cell base station.

Similarly, as shown in FIG. 9, when the macro cell base station carries the CSI-RS by the 6th sub-frame, the transmission of the CSI-RS of the macro cell base station may bring interference to the 4th sub-frame of the pico cell base station. In the present embodiment, the SIB1 channel does not occupy the 4th sub-frame, and the Paging channel may not occupy the 4th sub-frame (in the case that the Paging channel is configured to occupy the 9th sub-frame), therefore, it can be ensured that the SIB1 channel and the Paging channel of the pico cell base station are not interfered with by the CSI-RS transmitted in the macro cell base station.

As described above, in the present embodiment, when the macro cell base station carries the CSI-RS by the 2th sub-frame, the 2th sub-frame for carrying the CSI-RS of the macro cell base station is overlapped with the 0th sub-frame occupied by a part of the common channels of the pico cell base station (ie., the PBCH channel, the PSS channel and the SSS channel), ie., bring interference to these common channels.

In a preferred embodiment of the present invention, the interference on the above common channels caused by the CSI-RS may be alleviated by a manner of adjusting the CSI-RS symbol bits.

As can be seen in Table 1, the OFDM symbol position of the PBCH channel, the PSS channel and the SSS channel in a resource block may be (7, 8, 9, 10), 6, 5 respectively.

In the preferred embodiment, when the macro cell base station carries the CSI-RS by the 2th sub-frame, the macro cell base station can carry the CSI-RS in the 12th symbol bit and the 13th symbol bit of the resource block, ie., carry the CSI-RS in a position different from the symbol position of the common channel in the resource block. Therefore, the interference on the PBCH channel, the PSS channel and the SSS channel can be alleviated.

As to the above sample scenario, in the modified embodiment of the present invention, the transmission frame of the pico cell base station can also be postponed by 3 sub-frames. In the case, the macro cell base station can carry the CSI-RS by the 3th sub-frame or the 7th sub-frame in addition to the 1th sub-frame and/or the 6th sub-frame of the above preferred example 1.

FIG. 10 is a schematic diagram illustrating a transmission frame of a macro cell base station and a transmission frame of a pico cell base station according to the above modified embodiment of the present invention. As shown in FIG. 10, in addition to the 1th sub-frame and/or the 6th sub-frame of the preferred example 1, the macro cell base station can carry the CSI-RS by the 3th sub-frame or the 7th sub-frame to ensure that the SIB1 channel and the Paging channel of the pico cell base station is not interfered with by the CSI-RS transmitted by the macro cell base station.

Further considering the requirements for periodicity of the CSI-RS transmission shown in Table 1, it can be seen that the transmission configuration scheme for interference coordination that can be realized in the embodiment shown in FIG. 10 including: a macro cell base station transmits the CSI-RS using the 1th sub-frame and/or the 6th sub-frame (whether to use the 1th sub-frame and the 6th sub-frame simultaneously is determined according to the transmission period) of the transmission frame (such as a transmission frame of 10 sub-frames); or transmits the CSI-RS using the 3th sub-frame or the 7th sub-frame.

Referring to Table 1, the SIB1 channel occupies the 5th sub-frame of the frame, and the Paging channel may occupy the 0th, 4th, 5th, 9th sub-frames, the 9th sub-frame or the 4th, 9th sub-frames. In the present embodiment, the Paging channel can be advantageously configured to occupy the 9th sub-frame or the 4th, 9th sub-frames.

As shown in FIG. 10, when the macro cell base station carries the CSI-RS by the 3th sub-frame, the transmission of the CSI-RS in the macro cell base station may bring interference to the 0th sub-frame of the pico cell base station. In the present embodiment, the SIB1 channel does not occupy the 0th sub-frame, and the Paging channel may not occupy the 0th sub-frame (in the case that the Paging channel is configured to occupy the 9th sub-frame or the 4th, 9th sub-frames), therefore, it can be ensured that the SIB1 channel and the Paging channel of the pico cell base station are not interfered with by the CSI-RS transmitted in the macro cell base station.

As shown in FIG. 10, when the macro cell base station carries the CSI-RS by the 7th sub-frame, the transmission of the CSI-RS in the macro cell base station may bring interference to the 4th sub-frame of the pico cell base station. In the present embodiment, the SIB1 channel does not occupy the 4th sub-frame, and the Paging channel may not occupy the 4th sub-frame (in the case that the Paging channel is configured to occupy the 9th sub-frame), therefore, it can be ensured that the SIB 1 channel and the Paging channel of the pico cell base station are not interfered with by the CSI-RS transmitted in the macro cell base station.

As described above, in the present embodiment, when the macro cell base station carries the CSI-RS by the 3th sub-frame, the 0th sub-frame of the pico cell base station (ie., the PBCH channel, the PSS channel and the SSS channel) may be interfered with.

In a preferred embodiment of the present invention, the interference on the above common channels caused by the CSI-RS may be alleviated by a manner of adjusting the CSI-RS symbol bits.

As can be seen in Table 1, the OFDM symbol position of the PBCH channel, the PSS channel and the SSS channel in a resource block may be (7, 8, 9, 10), 6, 5 respectively.

Thus, in order to alleviate the interference on the above common channels cause by the CSI-RS, in the preferred embodiment, when the macro cell base station carries the CSI-RS by the 3th sub-frame, the macro cell base station can carry the CSI-RS in the 12th symbol bit and the 13th symbol bit of the resource block, ie., carry the CSI-RS in a position different from the symbol position of the common channel in the resource block to alleviate the interference on the PBCH channel, the PSS channel and the SSS channel.

Example scenario 2 in which the interference on the Paging channel caused by the CSI-RS of the macro cell base station may be allowed

In some applications in which the interference on the Paging channel caused by the CSI-RS of the macro cell base station may be allowed, the limitations to the position of the sub-frame for carrying the CSI-RS of the macro cell base station can be alleviated as appropriate.

Considering the above preferred example 1 and 2, it can be seen that, to ensure that the common channel of the macro cell base station will not bring interference to the common channel of the pico cell base station, the pico cell base station may postpone the transmission frame thereof by 2 sub-frames or 3 sub-frames.

As to the sample scenario 2, in the modified embodiment of the present invention, the transmission frame of the pico cell base station can be postponed by 2 sub-frames. In the case, the macro cell base station can carry the CSI-RS by the 4th sub-frame and/or the 9th sub-frame in addition to the 3th sub-frame and/or the 8th sub-frame of the above preferred example.

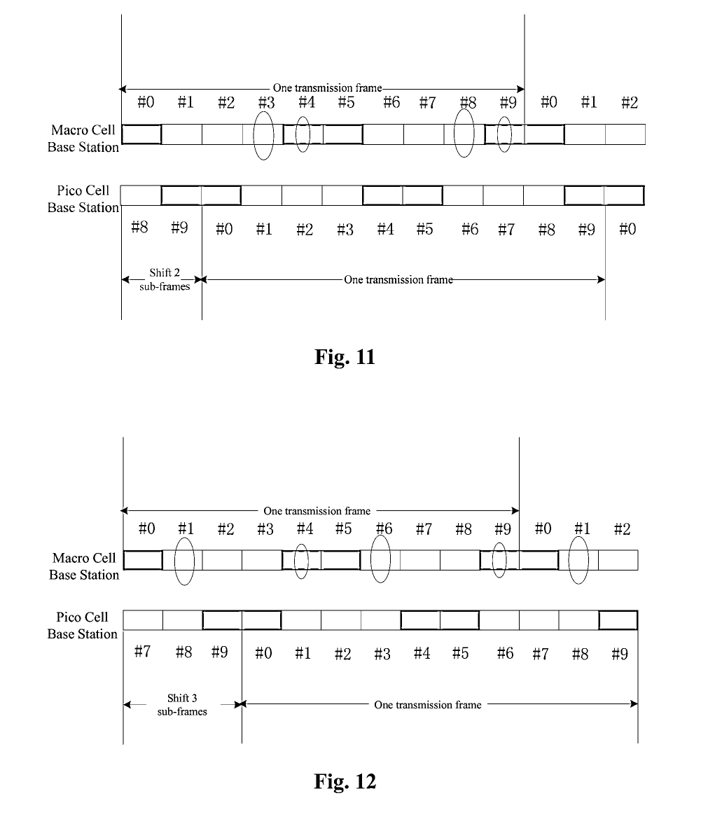

FIG. 11 is a schematic diagram illustrating a transmission frame of a macro cell base station and a transmission frame of a pico cell base station according to the above modified embodiment of the present invention. As shown in FIG. 11, the macro cell base station can carry the CSI-RS by the 4th sub-frame and/or the 9th sub-frame in addition to the 3th sub-frame and/or the 8th sub-frame of the above preferred example. When carrying the CSI-RS by the 4th sub-frame and/or the 9th sub-frame, there exists interference on the Paging channel caused by the CSI-RS of the macro cell base station.

Further considering the requirements for periodicity of the CSI-RS transmission shown in Table 1, it can be seen that the transmission scheme for interference coordination that can be realized in the embodiment shown in FIG. 11 including: a macro cell base station transmits the CSI-RS using the 3th sub-frame and/or the 8th sub-frame (whether to use the 3th sub-frame and the 8th sub-frame simultaneously is determined according to the transmission period) of the transmission frame (such as a transmission frame of 10 sub-frames); or using the 4th sub-frame and/or the 9th sub-frame (whether to use the 4th sub-frame and the 9th sub-frame simultaneously is determined according to the transmission period) of the transmission frame (such as a transmission frame of 10 sub-frames).

Referring to Table 1, the Paging channel may occupy the 0th, 4th, 5th, 9th sub-frames, the 9th sub-frame or the 4th, 9th sub-frames based on different configurations.

As shown in FIG. 11, when the macro cell base station carries the CSI-RS by the 4th sub-frame, the CSI-RS may bring interference to the Paging channel of the macro cell base station (for example, when the Paging channel occupies the 0th, 4th, 5th, 9th sub-frames or the 4th, 9th sub-frames), however, the CSI-RS does not bring interference to other common channels of the macro cell base station, nor to the common channels of the pico cell base station. Furthermore, the common channels of the macro cell base station do not interfere with the common channels of the pico cell base station.

Similarly, as shown in FIG. 11, when the macro cell base station carries the CSI-RS by the 9th sub-frame, the CSI-RS may bring interference to the Paging channel of the macro cell base station, however, the CSI-RS does not bring interference to other common channels of the macro cell base station, nor to the common channels of the pico cell base station. Furthermore, the common channels of the macro cell base station do not interfere with the common channels of the pico cell base station.

On the other hand, it can be seen from Table 1 that the transmission period of the CSI-RS may be 5 sub-frames, 10 sub-frames, 20 sub-frames or 40 sub-frames depending on different application scenarios.

For example, in the case that the interference on the Paging channel caused by the CSI-RS of the macro cell base station is allowed, if the transmission period is 10 sub-frames, 20 sub-frames or 40 sub-frames, the sub-frame for carry the CSI-RS of the macro cell base station may be the 4th sub-frame or the 9th sub-frame of the frame.

For example again, in the case that the interference on the Paging channel caused by the CSI-RS of the macro cell base station is allowed, if the transmission period is 5 sub-frames, the sub-frame for carry the CSI-RS of the macro cell base station may be the 4th sub-frame and the 9th sub-frame of the frame.

As to the example scenario 2, in a further modified embodiment of the present invention, a transmission frame of the pico cell base station 3 can be postponed by 3 sub-frames. In this case, the macro cell base station can carry the CSI-RS by the 4th sub-frame and/or the 9th sub-frame in addition to the 1th sub-frame and/or the 6th sub-frame of the above preferred example.

FIG. 12 is a schematic diagram illustrating a transmission frame of a macro cell base station and a transmission frame of a pico cell base station according to a modified embodiment of the present invention. As shown in FIG. 12, the macro cell base station may carry the CSI-RS by the 4th sub-frame and/or the 9th sub-frame. When carrying the CSI-RS by the 4th sub-frame and/or the 9th sub-frame, there exists interference on the Paging channel caused by the CSI-RS of the macro cell base station.

Further considering the requirements for periodicity of the CSI-RS transmission shown in Table 1, it can be seen that the transmission configuration scheme for interference coordination that can be realized in the embodiment shown in FIG. 12 includes: a macro cell base station transmits the CSI-RS using the 1th sub-frame and/or the 6th sub-frame (whether to use the 1th sub-frame and the 6th sub-frame simultaneously is determined according to the transmission period) of the transmission frame (such as a transmission frame of 10 sub-frames); or using the 4th sub-frame and/or the 9th sub-frame (whether to use the 4th sub-frame and the 9th sub-frame simultaneously is determined according to the transmission period) of the transmission frame (such as a transmission frame of 10 sub-frames).

Referring to Table 1, the Paging channel may occupy the 0th, 4th, 5th, 9th sub-frames, the 9th sub-frame or the 4th, 9th sub-frames based on different configurations.

As shown in FIG. 12, when the macro cell base station carries the CSI-RS by the 4th sub-frame, the CSI-RS may bring interference to the Paging channel of the macro cell base station (for example, when the Paging channel occupies the 0th, 4th, 5th, 9th sub-frames or the 4th, 9th sub-frames), however, the CSI-RS does not bring interference to other common channels of the macro cell base station, nor to the common channels of the pico cell base station. Furthermore, the common channels of the macro cell base station do not interfere with the common channels of the pico cell base station.

Similarly, as shown in FIG. 12, when the macro cell base station carries the CSI-RS by the 9th sub-frame, the CSI-RS may bring interference to the Paging channel of the macro cell base station, however, the CSI-RS does not bring interference to other common channels of the macro cell base station, nor to the common channels of the pico cell base station. Furthermore, the common channels of the macro cell base station do not interfere with the common channels of the pico cell base station.

On the other hand, it can be seen from Table 1 that the transmission period of the CSI-RS may be 5 sub-frames, 10 sub-frames, 20 sub-frames or 40 sub-frames depending on different application scenarios.

For example, in the case that there exists interference on the Paging channel of the macro cell base station caused by the CSI-RS of the macro cell base station, if the transmission period is 10 sub-frames, 20 sub-frames or 40 sub-frames, the sub-frame for carry the CSI-RS of the macro cell base station may be the 4th sub-frame or the 9th sub-frame of the frame.

For example again, in the case that there exists interference on the Paging channel caused by the CSI-RS of the macro cell base station, if the transmission period is 5 sub-frames, the sub-frame for carry the CSI-RS of the macro cell base station may be the 4th sub-frame and the 9th sub-frame of the frame.

Example scenario 3 in which the interference on the Paging channel on the 4th sub-frame of the pico cell base station caused by the CSI-RS of the macro cell base station may be allowed

As can be seen in Table 1, Paging channels may occupy the 9th sub-frame, the 4th, 9th sub-frames or the 0th, 4th, 5th, 9th sub-frames. In example scenario 3 of the present invention, for example, only the interference on the Paging channel on the 4th sub-frame caused by the CSI-RS transmitted by the macro cell base station is allowed, and it needs to be ensured that the CSI-RS transmitted by the macro cell base station will not bring interference to the Paging channel on other sub-frames. In this case, the limitations to the position of the sub-frame for carrying the CSI-RS of the macro cell base station can be alleviated as appropriate.

Considering the above preferred example 1 and 2, it can be seen that, to ensure that the common channel of the macro cell base station will not bring interference to the common channel of the pico cell base station, the pico cell base station may postpone the transmission frame by 2 sub-frames or 3 sub-frames.

As to example scenario 3, in a modified embodiment of the present invention, the transmission frame of the pico cell base station may be postponed by 2 sub-frames. In the case, the macro cell base station can carry the CSI-RS by the 6th sub-frame in addition to the 3th sub-frame and/or the 8th sub-frame of the above preferred example.

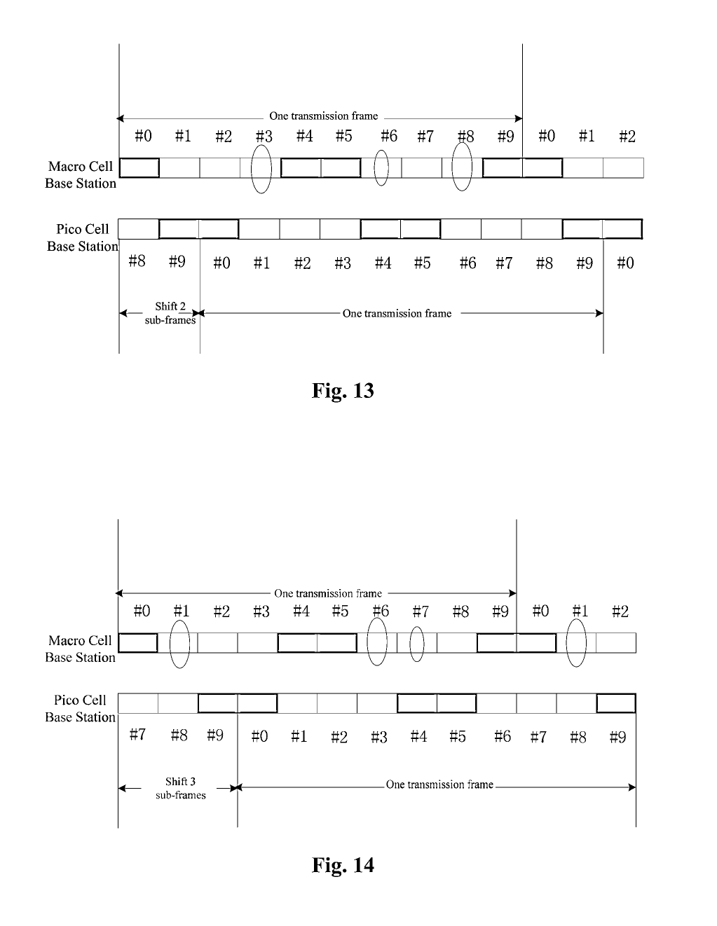

FIG. 13 is a schematic diagram illustrating a transmission frame of a macro cell base station and a transmission frame of a pico cell base station according to the above modified embodiment of the present invention. As shown in FIG. 13, the macro cell base station can carry the CSI-RS by the 6th sub-frame. When carrying the CSI-RS by the 6th sub-frame, there exists interference on the Paging channel occupying the 4th sub-frame of the pico cell base station caused by the CSI-RS of the macro cell base station.

Further considering the requirements for periodicity of the CSI-RS transmission shown in Table 1, it can be seen that the transmission configuration scheme for interference coordination that can be realized in the embodiment shown in FIG. 13 includes: a macro cell base station transmits the CSI-RS using the 3th sub-frame and/or the 8th sub-frame (whether to use the 3th sub-frame and the 8th sub-frame simultaneously is determined according to the transmission period) of the transmission frame (such as a transmission frame of 10 sub-frames); or transmits the CSI-RS using the 6th sub-frame of the frame.

As shown in FIG. 13, when the macro cell base station carries the CSI-RS by the 6th sub-frame, the CSI-RS may bring interference to the Paging channel of the macro cell base station (for example, when the Paging channel occupies the 4th sub-frame), however, the CSI-RS does not bring interference to the common channels of the pico cell base station, nor to the other common channels of the macro cell base station. Furthermore, the common channels of the macro cell base station do not interfere with the common channels of the pico cell base station.

Furthermore, as to example scenario 3, in a further modified embodiment of the present invention, the transmission frame of the pico cell base station may be postponed by 3 sub-frames, in this case, the macro cell base station can carry the CSI-RS by the 7th sub-frame in addition to the 1th sub-frame and/or the 6th sub-frame of the above preferred example.

FIG. 14 is a schematic diagram illustrating a transmission frame of a macro cell base station and a transmission frame of a pico cell base station according to the above modified embodiment of the present invention. As shown in FIG. 14, the macro cell base station may carry the CSI-RS by the 7th sub-frame. In this case, there exists interference on the Paging channel occupying the 4th sub-frame of the pico cell base station caused by the CSI-RS of the macro cell base station.

Further considering the requirements for periodicity of the CSI-RS transmission shown in Table 1, it can be seen that the transmission configuration scheme for interference coordination that can be realized in the embodiment shown in FIG. 14 includes: a macro cell base station transmits the CSI-RS using the 1th sub-frame and/or the 6th sub-frame (whether to use the 3th sub-frame and the 8th sub-frame simultaneously is determined according to the transmission period) of the transmission frame (such as a transmission frame of 10 sub-frames); or transmits the CSI-RS using the 7th sub-frame of the frame.

As shown in FIG. 14, when the macro cell base station carries the CSI-RS by the 7th sub-frame, the CSI-RS may bring interference to the Paging channel of the macro cell base station (for example, when the Paging channel occupies the 4th sub-frame), however, the CSI-RS does not bring interference to the common channels of the pico cell base station, nor to the other common channels of the macro cell base station. Furthermore, the common channels of the macro cell base station do not interfere with the common channels of the pico cell base station.

Example Scenario 4 in which the interference on the Paging channel of the pico cell base station caused by the common channel of the macro cell base station may be allowed

Considering the above preferred example 1 and 2, it can be seen that, when the pico cell base station postpones the transmission frame by 2 sub-frames or 3 sub-frames, it can be ensured that the common channel of the macro cell base station do not bring interference to the common channel of the pico cell base station. However, in Example Scenario 4 in which the interference on the Paging channel of the pico cell base station caused by the common channel of the macro cell base station may be allowed, the transmission frame of the pico cell base station may be postponed by 1 sub-frame.

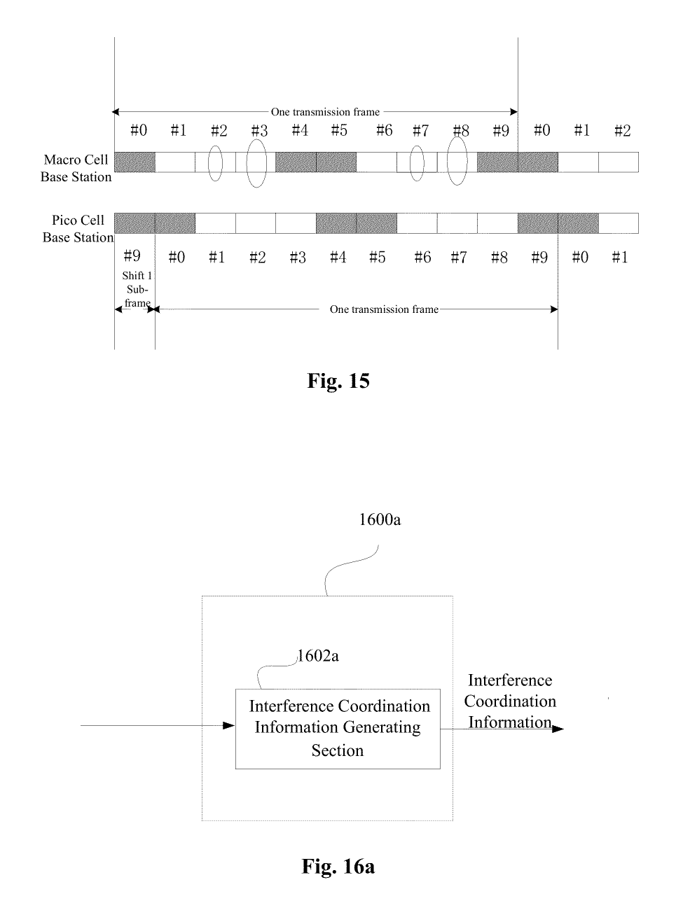

In a modified embodiment of the present invention, the transmission frame of the pico cell base station may be postponed by 1 sub-frame. In this case, as shown in FIG. 15, the macro cell base station may transmit the CSI-RS by the 2th and/or the 7th sub-frame or transmit the CSI-RS by the 3th and/or the 8th sub-frame.

More specifically, Further considering the requirements for periodicity of the CSI-RS transmission shown in Table 1, it can be seen that the transmission configuration scheme for interference coordination that can be realized in the embodiment shown in FIG. 15 includes: a macro cell base station transmits the CSI-RS using the 2th sub-frame and/or the 7th sub-frame (whether to use the 2th sub-frame and the 7th sub-frame simultaneously is determined according to the transmission period) of the transmission frame (such as a transmission frame of 10 sub-frames); or using the 3th sub-frame and/or the 8th sub-frame (whether to use the 3th sub-frame and the 8th sub-frame simultaneously is determined according to the transmission period) of the transmission frame (such as a transmission frame of 10 sub-frames).

FIG. 15 is a schematic diagram illustrating a transmission frame of a macro cell base station and a transmission frame of a pico cell base station according to a modified embodiment of the present invention.

As shown in FIG. 15, the transmission frame of the pico cell base station is postponed by 1 sub-frame, therefore, the common channel occupying the 0th sub-frame of the macro cell base station (for example, the PBCH channel, the PSS channel, the SSS channel and the like) may bring interference to the Paging channel occupying the 9th sub-frame of the pico cell base station; and, the common channel occupying the 5th sub-frame of the macro cell base station (for example, the PSS channel, the SSS channel, the SIB1 channel and the like) may bring interference to the Paging channel occupying the 4th sub-frame of the pico cell base station.

In the case that the transmission frame of the pico cell base station is postponed by 1 sub-frame as shown in FIG. 15, when the macro cell base station carries the CSI-RS by the 2th, 3th, 7th or 8th sub-frame, the sub-frame for carrying the CSI-RS is not overlapped with the sub-frame occupied by the common channel of the pico cell base station, ie., not bring interference to the common channel of the pico cell base station.

On the other hand, it can be seen from Table 1 that the transmission period of the CSI-RS may be 5 sub-frames, 10 sub-frames, 20 sub-frames or 40 sub-frames depending on different application scenarios.

For example, in the case that the transmission period of the CSI-RS is 10 sub-frames, 20 sub-frames or 40 sub-frames, the sub-frame for carrying the CSI-RS of the macro cell base station may be the 2th, 3th, 7th or 8th sub-frame to meet the requirements for the transmission period of the CSI-RS.

For example again, in the case that the transmission period of the CSI-RS is 5 sub-frames, the sub-frame for carrying the CSI-RS of the macro cell base station may be the 3th sub-frame and the 8th sub-frame of the frame to meet the requirements for the transmission period of the CSI-RS, or the 2th sub-frame and the 7th sub-frame of the frame to meet the requirements for the transmission period of the CSI-RS.

Corresponding to the methods of the above embodiments, the embodiment of the present invention also provides a corresponding device.

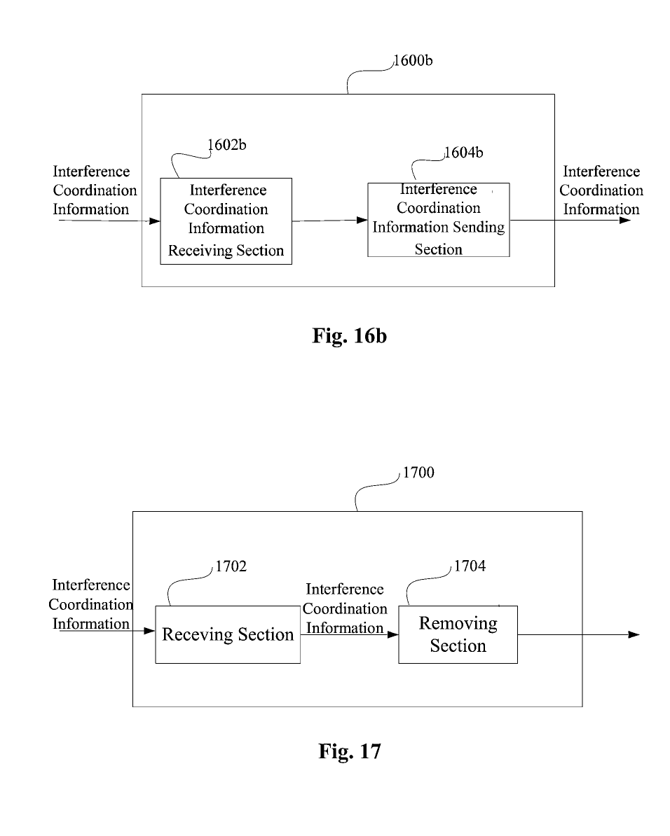

FIG. 16a illustrates a device for interference coordination according to an embodiment of the present invention.

As shown in FIG. 16a, the device for interference coordination 1600a according to the embodiment comprises a interference coordination information generating section 1602a.

The device 1600a illustrated in FIG. 16a may be configured at the macro cell base station, and can generate and send the CSI-RS related interference coordination information to a pico cell base station.

Specifically, the interference coordination information generating section 1602a can collect the CSI-RS related configuration information, and send these configuration information as interference coordination information to related pico cell base station via the interface between the base stations (for example, X2 interface).

FIG. 16b illustrates a device for interference coordination according to another embodiment of the present invention.

As shown in FIG. 16b, the device for interference coordination according to the embodiment may comprise an interference coordination information receiving section 1602b and an interference coordination information sending section 1604b.

The interference coordination information receiving section 1602b may receive the CSI-RS related interference coordination information of the macro cell base station from the macro cell base station of the communication system.

The interference coordination information sending section 1604b may send the CSI-RS related interference coordination information received from the macro cell base station to the UE served by the pico cell base station through the communication signaling between the UE and the base station (for example, a radio resource control signaling, i.e., a RRC signaling)

Thus, the device 1600b according to the embodiment for sending interference coordination information can send the CSI-RS related interference coordination information to the UE, facilitating the realization of interference coordination. Furthermore, the device 1600b illustrated in FIG. 16b may be configured at the pico cell base station.

In an specific embodiment of the present invention, the CSI-RS related interference coordination information collected by the macro cell base station and sent by the pico cell base station to the UE served by the pico cell base station may include, for example: a period of the CSI-RS, a position of a sub-frame carrying the CSI-RS, a position of the CSI-RS in time-frequency resources, a transmission symbol of the CSI-RS and a transmission power of the CSI-RS.

With the above-described CSI-RS related information, the information related to the CSI-RS transmission can be provided to the UE. Thus, the UE may also eliminate the information from the received information based on the CSI-RS related interference coordination information.

FIG. 17 illustrates a schematic diagram of a device for interference coordination according to an embodiment of the present invention.

As shown in FIG. 17, the device for interference coordination 1700 includes: a receiving section 1702; an eliminating section 1704.

The receiving section 1702 may receive the CSI-RS related interference coordination information collected by the macro cell base station from the pico cell base station.

The eliminating section 1704 may eliminate the interference caused by the CSI-RS from the received information based on the received interference coordination message.

Thus, the device for interference coordination 1700 according to an embodiment of the present invention may eliminate the interference on the pico cell base station caused by the macro cell base station. More specifically, the device for interference coordination 1700 may eliminate the interference on the pico cell base station caused by the macro cell base station transmitting the CSI-RS.

According to an embodiment of the present invention, the eliminating section may include an interference position determining section, a judging section and an interference eliminating section.

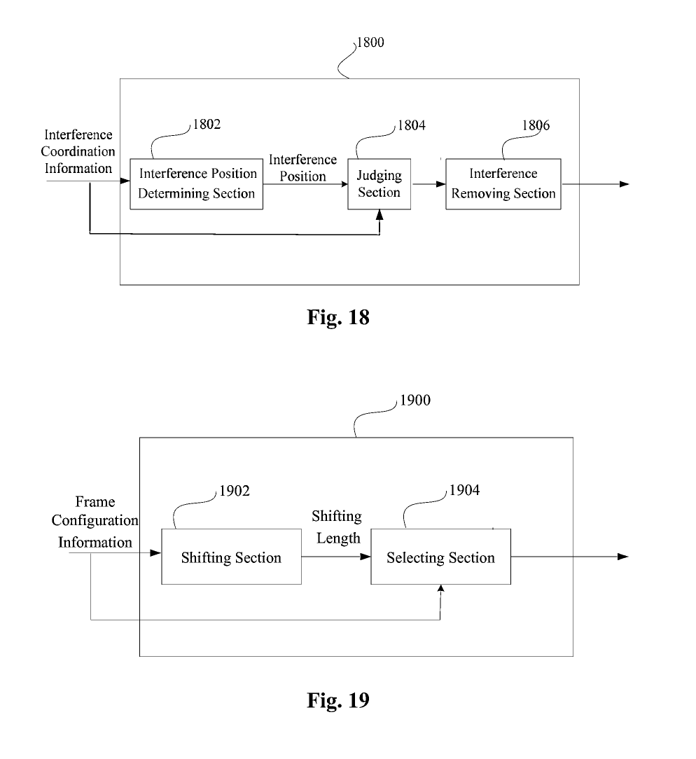

FIG. 18 illustrates a schematic diagram of an eliminating section according to an embodiment of the present invention. As shown in FIG. 18, the eliminating section 1800 may include: an interference position determining section 1802, a judging section 1804 and an interference eliminating section 1806.

The interference position determining section 1802 may determine the position of the interference according to the interference coordinate information from the receiving section.

Specifically, the interference position determining part 1802 may determine the position of the sub-frame for carrying the CSI-RS of the macro cell base station according to a period of the CSI-RS, a position of a sub-frame carrying the CSI-RS, a position of the CSI-RS in time-frequency resources in the CSI-RS related interference coordinate information. Thus, the interference position can be determined.

The judging section 1804 may judge whether a resource scheduling exists at the interference position.

Specifically, if the judging section 1804 found that there exists no information transmission at the interference position, the judging section 1804 can determine that no resource scheduling exists at the interference position and no process needs to be done.

On the other hand, if the judging section 1804 found that there exists information transmission at the interference position, the judging section 1804 can determine that resource scheduling exists at the interference position and inform the interference eliminating section 1806 to process.

The interference eliminating section 1806 may eliminate the affection of the interference from the received signal according to the interference coordination information.

Specifically, the interference eliminating section 1806 may further determine the magnitude of the interference according to the transmission symbol of the CSI-RS and the transmission power of the CSI-RS in the interference coordinate information, and eliminate the affection of the interference from the received signal at the position of the interference based on the determined magnitude of the interference.

In this way, the UE may eliminate the affection caused by the macro cell base station transmitting the CSI-RS from the received information, thus ensuring the quality of the received information.

The device for interference coordination according to the above-described embodiment may eliminate the affection of interference from the received signal based on the interference coordination information from the base station side. That is, the device for interference coordination according to the above-described embodiment may eliminate the interference on the pico cell base station caused by the macro cell base station transmitting the CSI-RS.

However, the device provided above is just an example, the present invention is not limited thereto. In another embodiment of the present invention, another device for interference coordination is provided.

FIG. 19 illustrates a device for interference coordination according to another embodiment of the present invention.

As shown in FIG. 19, the device may include a postponing section 1902 and a selecting section 1904.

The postponing section 1902 may postpone the transmission frame of the pico cell base station based on the frame structure of the macro cell base station, and the selecting section 1904 may select a sub-frame for carrying the CSI-RS from the transmission frame of the macro cell base station according to a postponing length of the transmission frame of the pico cell base station. The postponing section 1902 and the selecting section 1904 make processes such that: the sub-frame for carrying the CSI-RS selected by the selecting section 1904 is at least partly not overlapped with sub-frames for carrying common channels of the macro cell base station and sub-frames for carrying common channels of the pico cell base station; and the sub-frames for carrying common channels of the macro cell base station is at least partly not overlapped with the sub-frames for carrying common channels of the pico cell base station.

In one embodiment of the present invention, the postponing section 1902 may postpone the transmission frame of the pico cell base station by 2 sub-frames, and the selecting section 1904 may select the 3th sub-frame and/or the 8th sub-frame of the transmission frame of the macro cell base station to carry the CSI-RS.

FIG. 7 is a schematic diagram illustrating a transmission frame of a macro cell base station and a transmission frame of a pico cell base station according to the embodiment. As shown in FIG. 7, the selected sub-frame for carrying the CSI-RS of the macro cell base station is not overlapped with sub-frames for carrying common channels of the macro cell base station and sub-frames for carrying common channels of the pico cell base station; and the sub-frames for carrying common channels of the macro cell base station is not overlapped with the sub-frames for carrying common channels of the pico cell base station.

Thereby, the interference on the common channel of the pico cell base station caused by the common channel of the macro cell base station and the interference on the common channel of the macro cell base station and the common channel of the pico cell base station caused by the CSI-RS of the macro cell base station can be completely eliminated.

As to the specific configuration of the transmission frame of the macro cell base station and the transmission frame of the pico cell base station shown in FIG. 7, the above description for the method embodiment with reference to FIG. 7 may be referred to, and it is not repeated herein to keep the description concise.

In another embodiment of the present invention, the postponing section may postpone the transmission frame of the pico cell base station by 3 sub-frames, and the selecting section may select the 1th sub-frame and/or the 6th sub-frame of the transmission frame of the macro cell base station to carry the CSI-RS.

FIG. 8 is a schematic diagram illustrating a transmission frame of a macro cell base station and a transmission frame of a pico cell base station according to the embodiment. As shown in FIG. 8, the selected sub-frame for carrying the CSI-RS of the macro cell base station is not overlapped with sub-frames for carrying common channels of the macro cell base station and sub-frames for carrying common channels of the pico cell base station; and the sub-frames for carrying common channels of the macro cell base station is not overlapped with the sub-frames for carrying common channels of the pico cell base station.

Thereby, the interference on the common channel of the pico cell base station caused by the common channel of the macro cell base station and the interference on the common channel of the macro cell base station and the common channel of the pico cell base station caused by the CSI-RS of the macro cell base station can be completely eliminated.

As to the specific configuration of the transmission frame of the macro cell base station and the transmission frame of the pico cell base station shown in FIG. 8, the above description for the method embodiment with reference to FIG. 8 may be referred to, and it is not repeated herein to keep the description concise.

In a modified embodiment of the present invention, the postponing section may shift the transmission frame of the pico cell base station backwards by 2 sub-frames, and the selecting section may select the 2th sub-frame or the 6th sub-frame of the transmission frame of the macro cell base station to carry the CSI-RS.

FIG. 9 is a schematic diagram illustrating a transmission frame of a macro cell base station and a transmission frame of a pico cell base station according to the embodiment. As shown in FIG. 9, the selected sub-frame for carrying the CSI-RS of the macro cell base station is not overlapped with sub-frames for carrying common channels of the macro cell base station and is not partly overlapped with sub-frames for carrying common channels of the pico cell base station; and the sub-frames for carrying common channels of the macro cell base station is not overlapped with the sub-frames for carrying common channels of the pico cell base station.

As to the specific configuration of the transmission frame of the macro cell base station and the transmission frame of the pico cell base station shown in FIG. 9, the above description for the method embodiment with reference to FIG. 9 may be referred to, and it is not repeated herein to keep the description concise.

In another modified embodiment of the present invention, the postponing section may postpone the transmission frame of the pico cell base station by 3 sub-frames, and the selecting section may select the 3th sub-frame or the 7th sub-frame of the transmission frame of the macro cell base station to carry the CSI-RS.

FIG. 10 is a schematic diagram illustrating a transmission frame of a macro cell base station and a transmission frame of a pico cell base station according to the embodiment. As shown in FIG. 10, the selected sub-frame for carrying the CSI-RS of the macro cell base station is not overlapped with sub-frames for carrying common channels of the macro cell base station and is not partly overlapped with sub-frames for carrying common channels of the pico cell base station; and the sub-frames for carrying common channels of the macro cell base station is not overlapped with the sub-frames for carrying common channels of the pico cell base station.

As to the specific configuration of the transmission frame of the macro cell base station and the transmission frame of the pico cell base station shown in FIG. 10, the above description for the method embodiment with reference to FIG. 10 may be referred to, and it is not repeated herein to keep the description concise.

In still another modified embodiment of the present invention, the postponing section may shift the transmission frame of the pico cell base station by 2 sub-frames, and the selecting section may select the 4th sub-frame and/or the 9th sub-frame of the transmission frame of the macro cell base station to carry the CSI-RS.

FIG. 11 is a schematic diagram illustrating a transmission frame of a macro cell base station and a transmission frame of a pico cell base station according to the embodiment. As shown in FIG. 11, the selected sub-frame for carrying the CSI-RS of the macro cell base station is not partly overlapped with sub-frames for carrying common channels of the macro cell base station and is not overlapped with sub-frames for carrying common channels of the pico cell base station; and the sub-frames for carrying common channels of the macro cell base station is not overlapped with the sub-frames for carrying common channels of the pico cell base station.

As to the specific configuration of the transmission frame of the macro cell base station and the transmission frame of the pico cell base station shown in FIG. 11, the above description for the method embodiment with reference to FIG. 11 may be referred to, and it is not repeated herein to keep the description concise.

In yet still another modified embodiment of the present invention, the postponing section may shift the transmission frame of the pico cell base station backwards by 3 sub-frames, and the selecting section may select the 4th sub-frame and/or the 9th sub-frame of the transmission frame of the macro cell base station to carry the CSI-RS.

FIG. 12 is a schematic diagram illustrating a transmission frame of a macro cell base station and a transmission frame of a pico cell base station according to the embodiment. As shown in FIG. 12, the selected sub-frame for carrying the CSI-RS of the macro cell base station is not partly overlapped with sub-frames for carrying common channels of the macro cell base station and is not overlapped with sub-frames for carrying common channels of the pico cell base station; and the sub-frames for carrying common channels of the macro cell base station is not overlapped with the sub-frames for carrying common channels of the pico cell base station.

As to the specific configuration of the transmission frame of the macro cell base station and the transmission frame of the pico cell base station shown in FIG. 12, the above description for the method embodiment with reference to FIG. 12 may be referred to, and it is not repeated herein to keep the description concise.

In yet still another modified embodiment of the present invention, the postponing section may postpone the transmission frame of the pico cell base station by 2 sub-frames, and the selecting section may select the 6th sub-frame of the transmission frame of the macro cell base station to carry the CSI-RS.

FIG. 13 is a schematic diagram illustrating a transmission frame of a macro cell base station and a transmission frame of a pico cell base station according to the embodiment. As shown in FIG. 13, the selected sub-frame for carrying the CSI-RS of the macro cell base station is not overlapped with sub-frames for carrying common channels of the macro cell base station and is not partly overlapped with sub-frames for carrying common channels of the pico cell base station; and the sub-frames for carrying common channels of the macro cell base station is not overlapped with the sub-frames for carrying common channels of the pico cell base station.

As to the specific configuration of the transmission frame of the macro cell base station and the transmission frame of the pico cell base station shown in FIG. 13, the above description for the method embodiment with reference to FIG. 13 may be referred to, and it is not repeated herein to keep the description concise.

In yet still another modified embodiment of the present invention, the postponing section may postpone the transmission frame of the pico cell base station by 3 sub-frames, and the selecting section may select the 7th sub-frame of the transmission frame of the macro cell base station to carry the CSI-RS.

FIG. 14 is a schematic diagram illustrating a transmission frame of a macro cell base station and a transmission frame of a pico cell base station according to the embodiment. As shown in FIG. 14, the selected sub-frame for carrying the CSI-RS of the macro cell base station is not overlapped with sub-frames for carrying common channels of the macro cell base station and is not partly overlapped with sub-frames for carrying common channels of the pico cell base station; and the sub-frames for carrying common channels of the macro cell base station is not overlapped with the sub-frames for carrying common channels of the pico cell base station.

As to the specific configuration of the transmission frame of the macro cell base station and the transmission frame of the pico cell base station shown in FIG. 14, the above description for the method embodiment with reference to FIG. 14 may be referred to, and it is not repeated herein to keep the description concise.

In yet still another modified embodiment of the present invention, the postponing section may postpone the transmission frame of the pico cell base station by 1 sub-frame, and the selecting section may select the 3th sub-frame and/or the 8th sub-frame, or select the 2th sub-frame and/or the 7th sub-frame of the transmission frame of the macro cell base station to carry the CSI-RS.

FIG. 15 is a schematic diagram illustrating a transmission frame of a macro cell base station and a transmission frame of a pico cell base station according to the embodiment. As shown in FIG. 15, the selected sub-frame for carrying the CSI-RS of the macro cell base station is not overlapped with sub-frames for carrying common channels of the macro cell base station and is not overlapped with sub-frames for carrying common channels of the pico cell base station; and the sub-frames for carrying common channels of the macro cell base station is not partly overlapped with the sub-frames for carrying common channels of the pico cell base station.

As to the specific configuration of the transmission frame of the macro cell base station and the transmission frame of the pico cell base station shown in FIG. 15, the above description for the method embodiment with reference to FIG. 15 may be referred to, and it is not repeated herein to keep the description concise.

Furthermore, by means of the device for interference coordination according to the described embodiment, the embodiments of the present invention provide a UE, a base station and a communication system accordingly.

One embodiment of the present invention provides a base station, said base station may include the device for interference coordination according to the embodiment described with reference to FIG. 16.

One embodiment of the present invention also provides a UE, said UE may include the device for interference coordination according to the embodiment described with reference to FIGS. 17, 18.

One embodiment of the present invention also provides a communication system, which includes at least one base station described above and at least one UE described above.

Furthermore, one embodiment of the present invention provides a base station, said base station may include the device for interference coordination according to the embodiment described in reference to FIG. 19.

Furthermore, one embodiment of the present invention provides a communication system, which includes at least one base station described above.

The skilled person will be aware of that the present invention may be embodied as a system, a method or a computer program product. Accordingly, the present invention may be embodied in the following forms, namely, an entire hardware, an entire software (including firmware, resident software, micro-code, etc.), or a combination of a software portion and a hardware portion generally called “circuit”, “module” or “System” herein. Furthermore, the present invention may take a form of computer program product embodied in any tangible medium of expression containing program code available in a computer.

Any combination of one or more computer-readable media can be used. The computer-readable medium may be a computer readable signal medium or a computer-readable storage medium. For example, the computer readable storage medium may be—but not limited to—an electrical, magnetic, optical, electromagnetic, infrared, or semiconductor system, device, element, or transmission medium, or any suitable combination of the foregoing terms. The specific example of the computer-readable storage medium (a non-exhaustive list) includes the following: an electrical connection having one or more wires, a portable computer disk, a hard disk, a random access memory (RAM), a read only memory (ROM), an erasable programmable read-only memory (EPROM or Flash memory), an optical fiber, a portable compact disk read-only memory (CD-ROM), an optical memory device, a magnetic memory device or any suitable combination of the foregoing terms. In this context, the computer-readable storage medium may be any tangible medium that contains or stores programs used for an instruction execution system, device, or element or associated with a instruction execution system, device, or element.

The computer-readable signal medium may include, for example, a data signal with a computer readable program code in a baseband or transmitted as part of a carrier. Such a transmission signal may take any suitable form, including—but not limited to—an electromagnetic signal, an optical signal, or any suitable combination thereof. The computer-readable signal medium may be any kind of computer program readable medium that is different from the computer-readable storage medium and can transfer, transport or transmit programs used for an instruction execution system, device, or element or associated with an instruction execution system, device, or element. The program code contained in the computer readable medium may be transmitted by any suitable medium, including—but not limited to—wireless, wired, optical cable, RF, etc., or any suitable combination of the foregoing terms.

The computer program code for carrying out the operation of the present invention may be written by any combination of one or more programming languages, said programming languages include an object-oriented programming language such as Java, Smalltalk, C++ and the like, and a conventional procedural programming language such as the “C” programming language or similar programming languages. The Program code can be completely executed on the user's computer, partly executed on the user's computer, executed as a stand-alone software package, executed partly on the user's computer and partly on a remote computer, or completely executed on the remote computer. In the latter scenario, the remote computer can connect to the user's computer via any kind of network-including a Local Area Network (LAN) or a wide area network (WAN), or connect to an external computer (for example, via the Internet by using the Internet service provider).

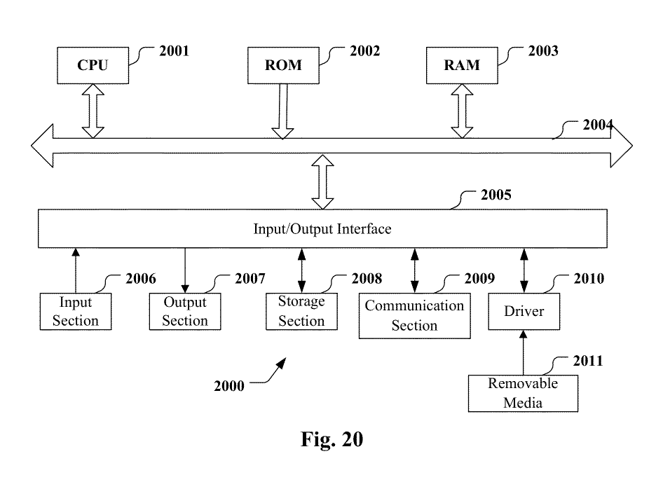

FIG. 20 is a block diagram illustrating an exemplary structure of a computer in which the device and the method of the present invention is implemented.

In FIG. 20, the central processing unit (CPU) 2001 executes various processing according to a program stored in the mapping data read-only (ROM) 2002 or a program loaded into the random accessible mapping data (RAM) 2003 from the memory part 2008. In the RAM 2003, the data required for the CPU 2001 to execute various processing is stored as necessary.

The CPU 2001, the ROM 2002 and the RAM 2003 connect to each other via a bus 2004. The input/output interface 2005 is also connected to the bus 2004.

The following components connect to the input/output interface 2005: an input part 2006, including a keyboard, a mouse, etc.; an output part 2007, including a display, such as a cathode ray tube (CRT), a liquid crystal display (LCD), etc., and a speaker etc.; the storage part 2008, including a hard disk and the like; and a communication part 2009, including a network interface card such as a LAN card, modem, etc. The communication part 2009 executes a communication process via a network such as the Internet.

The drive 2010 is also connected to the input/output interface 2005 as required. The removable media 2011, such as a magnetic disk, an optical disk, an magneto-optical disk, a semiconductor mapping data and the like, is installed on the drive 2010, such that a computer program read out therefrom is installed on the storage part 2008 as required.

In the case that the above steps and processes is implemented by software, the programs constituting the software is installed via a network such as the Internet or a storage medium such as the removable media 2011.

The skilled person will appreciate, this storage medium is not limited to the removable media 2011 shown in FIG. 20 in which a program is stored and the program is distributed separately with a method to be provided to a user. Examples of the removable media 2011 contain a magneto disk, an optical disk (including compact disc read only mapping data (CD-ROM) and a digital versatile disk (DVD)), a magneto-optical disk (including a mini disc (MD) and a semiconductor mapping data. Alternatively, the storage section 2008 may be a ROM 2002, a hard disk included in the storage section 2008 etc., in which programs are installed and are distributed to a user together with the method containing them.

The corresponding structures, materials, operations and the equivalent substitution of all functional defined devices (means) or steps of the following claims is direct to include any structures, materials, or operations for performing the function in combination with other units particularly pointed out in the claims. The given description of the present invention is intent to illustrate and describe, not exhaustively, and it is not to limit the invention to the described form. For the skilled person in this field, it is clear that many modifications and variations may be made without departing from the scope and spirit of the present invention. The selection and description of the embodiments is intent to best explain the principle and practical application of the present invention, make the skilled person to understand that the invention may have various embodiments with various changes suit to specific purposes.

1. A method for coordinating interference in a communication system, comprising:
collecting and sending, by a macro-cell base station in the communication system, interference coordination information in connection with Channel State Information-Reference Signal of the macro cell base station, to a pico cell base station; and
sending, by the pico cell base station, the interference coordination information to a user equipment serviced by the pico cell base station so as to coordinate interference on the pico cell caused by the macro cell according to the interference coordination information.

2. The method according to claim 1, wherein, the interference coordination information comprises a period of the Channel State Information-Reference Signal, a position of a sub-frame carrying the Channel State Information-Reference Signal, a position of the Channel State Information-Reference Signal in time-frequency resources, a transmission symbol of the Channel State Information-Reference Signal and a transmission power of the Channel State Information-Reference Signal.

3. A method for coordinating interference in a communication system, comprising:
receiving, by a user equipment in the communication system, interference coordination information in connection with Channel State Information-Reference Signal of a macro cell base station from a pico cell base station serving the user equipment;
removing, by the user equipment, interference information from the received information according to the interference coordination information so as to eliminate the interference on the pico cell caused by the macro cell.

4. The method according to claim 3, wherein, the interference coordination information comprises: a period of the Channel State Information-Reference Signal, a position of a sub-frame carrying the Channel State Information-Reference Signal, a position of the Channel State Information-Reference Signal in time-frequency resources, a transmission symbol of the Channel State Information-Reference Signal and a transmission power of the Channel State Information-Reference Signal.

5. The method according to claim 4, wherein, the process for eliminating interference information from the received information comprises:
determining an interference position according to the interference coordination information;
judging whether a resource scheduling exists at the interference position;
if no resource scheduling exists, ending the process;
otherwise, eliminating the affection of the interference from a received signal according to the interference coordination information.

6. A method for coordinating interference in a communication system, comprising:
informing, by a marco cell base station in the communication system, a pico cell base station in the communication system to postpone a transmission frame of the pico cell base station according to a frame structure of the macro cell base station itself; and selecting, by the macro cell base station, a sub-frame for carrying the Channel State Information-Reference Signal from the transmission frame of the macro cell base station itself according to a postponing length of the transmission frame of the pico cell base station;
wherein, the sub-frame for carrying the Channel State Information-Reference Signal selected by the macro cell base station is at least partly not overlapped with sub-frames for carrying common channels of the macro cell base station and sub-frames for carrying common channels of the pico cell base station; and the sub-frames for carrying common channels of the macro cell base station is at least partly not overlapped with the sub-frames for carrying common channels of the pico cell base station.

7. The method according to claim 6, wherein,
the pico cell base station postpones the transmission frame for two sub-frames and the macro cell base station selects the third and/or the eighth sub-frame of the frame for carrying the Channel State Information-Reference Signal;
wherein, the sub-frame for carrying the Channel State Information-Reference Signal selected by the macro cell base station is not overlapped with sub-frames for carrying common channels of the macro cell base station and sub-frames for carrying common channels of the pico cell base station; and the sub-frames for carrying common channels of the macro cell base station is not overlapped with the sub-frames for carrying common channels of the pico cell base station.

8. The method according to claim 6, wherein,
the pico cell base station postpones the frame for three sub-frames and the macro cell base station selects the first and/or the sixth sub-frame for carrying the Channel State Information-Reference Signal;
wherein, the sub-frame for carrying the Channel State Information-Reference Signal selected by the macro cell base station is not overlapped with sub-frames for carrying common channels of the macro cell base station and sub-frames for carrying common channels of the pico cell base station; and the sub-frames for carrying common channels of the macro cell base station is not overlapped with the sub-frames for carrying common channels of the pico cell base station.

9. The method according to claim 6, wherein,
the pico cell base station postpones the frame for two sub-frames and the macro cell base station selects the second or the sixth sub-frame for carrying the Channel State Information-Reference Signal;
wherein, the sub-frame for carrying the Channel State Information-Reference Signal selected by the macro cell base station is not overlapped with sub-frames for carrying common channels of the macro cell base station and is partly not overlapped with sub-frames for carrying common channels of the pico cell base station; and the sub-frames for carrying common channels of the macro cell base station is not overlapped with the sub-frames for carrying common channels of the pico cell base station.

10. The method according to claim 6, wherein,
the pico cell base station postpones the frame for three sub-frames and the macro cell base station selects the third or the seventh sub-frame for carrying the Channel State Information-Reference Signal;
wherein, the sub-frame for carrying the Channel State Information-Reference Signal selected by the macro cell base station is not overlapped with sub-frames for carrying common channels of the macro cell base station and is partly not overlapped with sub-frames for carrying common channels of the pico cell base station; and the sub-frames for carrying common channels of the macro cell base station is not overlapped with the sub-frames for carrying common channels of the pico cell base station.

11. The method according to claim 6, wherein,
the pico cell base station postpones the frame for two sub-frames and the macro cell base station selects the fourth and/or the ninth sub-frame for carrying the Channel State Information-Reference Signal;
wherein, the sub-frame for carrying the Channel State Information-Reference Signal selected by the macro cell base station is partly not overlapped with sub-frames for carrying common channels of the macro cell base station and is not overlapped with sub-frames for carrying common channels of the pico cell base station; and the sub-frames for carrying common channels of the macro cell base station is not overlapped with the sub-frames for carrying common channels of the pico cell base station.

12. The method according to claim 6, wherein,
the pico cell base station postpones the frame for three sub-frames and the macro cell base station selects the fourth and/or the ninth sub-frame for carrying the Channel State Information-Reference Signal;
wherein, the sub-frame for carrying the Channel State Information-Reference Signal selected by the macro cell base station is partly not overlapped with sub-frames for carrying common channels of the macro cell base station and is not overlapped with sub-frames for carrying common channels of the pico cell base station; and the sub-frames for carrying common channels of the macro cell base station is not overlapped with the sub-frames for carrying common channels of the pico cell base station.

13. The method according to claim 6, wherein,
the pico cell base station postpones the frame for two sub-frames and the macro cell base station selects the sixth sub-frame for carrying the Channel State Information-Reference Signal;
wherein, the sub-frame for carrying the Channel State Information-Reference Signal selected by the macro cell base station is not overlapped with sub-frames for carrying common channels of the macro cell base station and is partly not overlapped with sub-frames for carrying common channels of the pico cell base station; and the sub-frames for carrying common channels of the macro cell base station is not overlapped with the sub-frames for carrying common channels of the pico cell base station.

14. The method according to claim 6, wherein,
the pico cell base station postpones the frame for three sub-frames and the macro cell base station selects the seventh sub-frame for carrying the Channel State Information-Reference Signal;
wherein, the sub-frame for carrying the Channel State Information-Reference Signal selected by the macro cell base station is not overlapped with sub-frames for carrying common channels of the macro cell base station and is partly not overlapped with sub-frames for carrying common channels of the pico cell base station; and the sub-frames for carrying common channels of the macro cell base station is not overlapped with the sub-frames for carrying common channels of the pico cell base station.

15. The method according to claim 6, wherein,
the pico cell base station postpones the frame for one sub-frame and the macro cell base station selects the third and/or the eighth sub-frame or selects the second and/or the seventh sub-frame for carrying the Channel State Information-Reference Signal;
wherein, the sub-frame for carrying the Channel State Information-Reference Signal selected by the macro cell base station is not overlapped with sub-frames for carrying common channels of the macro cell base station and sub-frames for carrying common channels of the pico cell base station; and the sub-frames for carrying common channels of the macro cell base station is partly not overlapped with the sub-frames for carrying common channels of the pico cell base station.

16. A device for coordinating interference in a communication system, comprising:
an interference coordination information generating section configured to generate interference coordination information in connection with Channel State Information-Reference Signal of the device in the communication system and send the interference coordination information to a pico cell base station in the communication system;
wherein, the interference coordination information is sent to a user equipment serviced by a pico cell base station, so as to coordinate interference on the pico cell caused by the macro cell according to the interference coordination information.

17. A device for coordinating interference in a communication system, comprising:
an interference coordination information receiving section configured to receive interference coordination information in connection with Channel State Information-Reference Signal of a macro cell base station in the communication system from the macro cell base station; and
an interference coordination information sending section configured to send the interference coordination information to a user equipment serviced by the device, so as to coordinate interference on the pico cell corresponding to the device caused by the macro cell according to the interference coordination information.

18. A device for coordinating interference in a communication system, comprising:
a receiving section configured to receive interference coordination information in connection with Channel State Information-Reference Signal of a macro cell base station in the communication system from a pico cell base station in the communication system;
an eliminating section configured to eliminate interference information from the received information according to the interference coordination information so as to eliminate the interference on the pico cell caused by the macro cell.

19. A device for coordinating interference in a communication system, comprising:
a postponing section configured to postpone a transmission frame of a pico cell base station in the communication system according to a frame structure of a macro cell base station in the communication system;
a selecting section configured to select a sub-frame for carrying the Channel State Information-Reference Signal from the transmission frame of the macro cell base station according to a postponing length of the transmission frame of the pico cell base station;
wherein, the sub-frame for carrying the Channel State Information-Reference Signal selected by the selecting section is at least partly not overlapped with sub-frames for carrying common channels of the macro cell base station and sub-frames for carrying common channels of the pico cell base station, and the sub-frames for carrying common channels of the macro cell base station is at least partly not overlapped with the sub-frames for carrying common channels of the pico cell base station.

20. A user equipment, comprising a device for coordinating interference in a communication system, the device for coordinating interference in a communication system comprising:
a receiving section configured to receive interference coordination information in connection with Channel State Information-Reference Signal of a macro cell base station in the communication system from a pico cell base station in the communication system;
an eliminating section configured to eliminate interference information from the received information according to the interference coordination information so as to eliminate the interference on the pico cell caused by the macro cell.
